(19) United States
(12) Patent Application Publication
(10) Pub. No.: US 2014/0175886 A1
(43) Pub. Date: Jun. 26, 2014

(54) Power System Having a Stabilized DC Link Voltage to Handle Transient Events

(71) Applicant: CATERPILLAR INC., Peoria, IL (US)

(72) Inventors: Wellington Kwok, Dunlap, IL (US); Andrew Knitt, Deer Creek, IL (US); Dachuan Yu, Normal, IL (US)

(73) Assignee: Caterpillar Inc., Peoria, IL (US)

(21) Appl. No.: 13/721,389

(22) Filed: Dec. 20, 2012

(51) Int. Cl. H02J 7/34

(52) U.S. Cl. CPC H02J 7/34
USPC 307/46

(57) ABSTRACT

A power system includes a prime mover configured to generate a drive force and a generator configured to receive the drive force and be driven by the prime mover to produce electrical power. The power system further includes a connection configured to receive the electrical power from the generator and direct the electrical power to an external load, a power storage device arranged in series with the connection between the generator and the external load, the power storage device configured to store electrical power from the generator or to discharge power to the external load, and a controller to control the power storage device. The Controller configured to determine a supply of electrical power and a demand for electrical power by the external load, the controller being further configured to control the power storage device. A method is also disclosed.

### FIELD

The disclosure relates generally to a power system having a device to control transient events. More particularly, the disclosure relates to a power system having a stabilized DC link to control transient events.

### BACKGROUND

A generator set typically includes a generator and a prime mover, for example a combustion engine. In a typical generator set, a mixture of fuel and air is burned within the combustion engine and a mechanical rotation is generated that drives the generator to produce electrical power. Ideally, the engine drives the generator and accordingly produces electrical power having relatively constant characteristics (frequency, voltage, etc.).

Generation sets are often used as a source of power, for example, to supply a hospital, a manufacturing facility, a military facility, or the like with power. Although effective, the generator set cannot respond immediately to sudden changes in power demand. As such, without intervention, a change in power demand can result in an interruption in power provided. On the other hand, if the generator set is implemented with a large prime mover and generator, changes in power demands are not as critical. However, cost, size, and/or weight of the generator set increase dramatically.

Generation sets may be used in conjunction with an uninterruptible power supply (UPS). In many cases, the UPS stores energy by drawing power from the power source. In this manner, the UPS functions as an energy storage device. Should there be a change in power demand, the UPS provides immediate additional power for the critical use until the generator set is brought up to speed, at which time the UPS may transfer load feeding responsibilities back to the generator set. However, the UPS typically must function as a parallel system and must be sized to produce substantially all of the power and voltage to handle the power demand. This increases the size, cost and/or weight of the UPS system

One attempt to minimize fluctuations in characteristics of the electrical power output provided by a generator set is described in U.S. Pat. No. 6,657,321 (the '321 patent) issued to Sinha on Dec. 2, 2003. The '321 patent discloses an uninterruptable power supply system having a turbine-driven generator and an energy storage system. The energy storage system is configured to supply a substantially constant DC load voltage by adjusting an amount of fuel supplied to the turbine and by adjusting an amount of supplemental DC power supplied by the energy storage system for use by the load. The energy storage system can be used to absorb and source transient power while the turbine control reacts to changes in the load. The energy storage system may include systems such as batteries, flywheels, superconducting magnetic energy storage systems, or combinations thereof. In one aspect, in response to an excess in DC load voltage, the energy storage system is used to absorb excess DC power. In a more specific aspect, the absorbing of excess DC power by the energy storage system is combined with supplying a decreased level of fuel in response to an excess in DC load voltage.

Although the system of the '321 patent may be helpful in minimizing power fluctuations in a DC power generating application, the system may be limited. That is, the system of the '321 patent may be inapplicable to AC power system applications. Moreover, the system of the '321 patent requires a larger generator set when utilizing the disclosed type and arrangement of energy storage system in order to address power fluctuations. This increases cost, weight, and/or size of the generator set. Finally, a larger energy storage system is required to address the change in power demand. This larger energy storage system increases cost, weight, and/or size of the energy storage system,

Accordingly, there is needed a less costly generator set that can minimize power fluctuations and prevent voltage drop when a load is applied.

### SUMMARY OF THE INVENTION

The foregoing needs are met, to a great extent, by the disclosure, wherein in one aspect a technique and apparatus are provided for a less costly generator set that can minimize power fluctuations and prevent voltage drop when a load is applied utilizing a smaller generator set.

In accordance with one aspect, a power system includes a prime mover configured to generate a drive force, a generator configured to receive the drive force and be driven by the prime mover to produce electrical power, a connection configured to receive the electrical power from the generator and direct the electrical power to an external load, a power storage device arranged in series with the connection between the generator and the external load, the power storage device configured to store electrical power from the generator or to discharge power to the external load, and a controller to control the power storage device, the controller configured to determine a supply of electrical power and a demand for electrical power by the external load, the controller being further configured to control the power storage device to store at least a portion of the electrical power to charge the power storage device or to discharge power to supplement the electrical power from the generator directed to the external load.

In accordance with another aspect, a power system includes means for producing a drive force, means for generating electrical power in response to receiving the drive force from the means for producing a drive force, means for connecting to receive the electrical power from the means for generating and the means for connecting further directing the electrical power to an external load, means for storing arranged in series with the means for connecting between the means for generating and the external load, the means for storing stores electrical power to charge the means for storing or to discharge power from the means for storing, and a means for controlling to control the means for storing and configured to determine a supply of electrical power and a demand for electrical power by the external load, the means for controlling being further configured to control the means for storing to store at least a portion of the electrical power from the means for generating to charge the means for storing or to discharge power from the means for storing to supplement the electrical power from the means for generating directed to the external load.

In accordance with yet another aspect, a process of operating a power system includes producing a drive force, generating electrical power in response to receiving the drive force, directing the electrical power to an external load, determining a supply of electrical power and a demand for electrical power by the external load, storing electrical power in a power storage device when the supply of electrical power is greater than the demand for electrical power by the external load, and discharging electrical power from the power storage device together with the directing the electrical power when the demand for electrical power is greater than the supply of electrical power by the external load.

### BRIEF DESCRIPTION OF THE DRAWINGS

FIG. 1 shows a generator set according to an aspect of the disclosure.

FIG. 2 shows a partial view of a generator set having a particular implementation according to an aspect of the disclosure.

FIG. 3 shows a flowchart illustrating a process for operating the power system according to an aspect of the disclosure.

FIG. 4 shows a generator set according to an aspect of the disclosure.

FIG. 5 shows a generator set according to an aspect of the disclosure.

FIG. 6 shows a generator set according to an aspect of the disclosure.

FIG. 7 shows a generator set according to an aspect of the disclosure.

FIG. 8 shows a generator set according to an aspect of the disclosure.

### DETAILED DESCRIPTION

The disclosure will now be described with reference to the drawing figures, in which like reference numerals refer to like parts throughout. Aspects of the disclosure advantageously provide a generator set that can minimize power fluctuations and prevent voltage drop when a load is applied utilizing a smaller generator set. Aspects of the disclosure advantageously further provide the ability to switch an energy storage source in-series with a DC Link voltage providing only partial DC Link voltage for transient voltage stabilization, i.e., after the system requests an increase in output power, an engine (or a downsized engine) may gradually ramp up a speed to a requested level while the energy storage is temporarily switched in-series to boost the DC Link voltage and support the continual operation on an Inverter side. Accordingly, this may allow the use of a smaller (and lower voltage and lower cost) energy storage system, and eliminate the traditional use of a high-power bidirectional DC/DC converter between energy storage and DC Link.

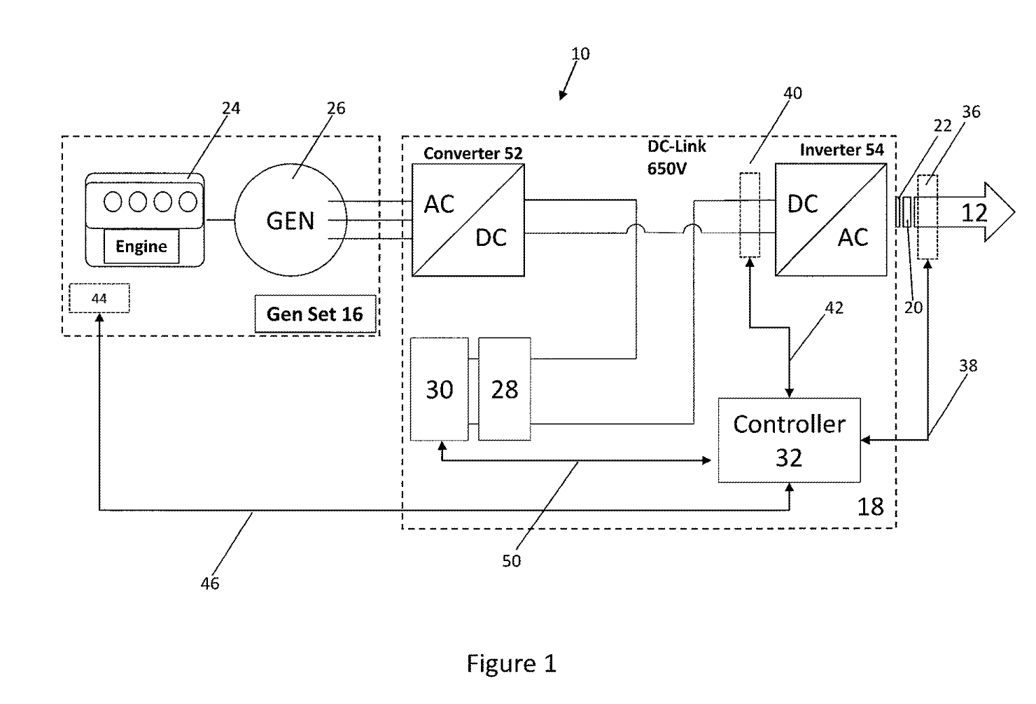

FIG. 1 shows a generator set according to an aspect of the disclosure. More specifically, FIG. 1 illustrates an exemplary power system 10 consistent with certain disclosed aspects. The power system 10 may be configured to provide power to an external load 12. In one exemplary aspect, the power system 10 may be configured as a primary source of power, if desired. It is contemplated, however, that in some aspects, the power system 10 may provide an immediate supply of reserve power provided to external load 12 when power supplied from a utility power grid 14 is interrupted.

As shown in FIG. 1, the power system 10 may include a generator set 16 and a transient management system 18. The generator set 16 and the transient management system 18 may be connected to each other and further connected to the external load 12 by way of a power transmission network 20 and a connection 22.

The power system 10 may be a self-supporting, electricity generation and/or distribution system such as, for example, a machine (e.g., construction equipment and/or agricultural equipment), motorized vehicle (e.g., a bus or a truck), a power supply for a remote facility, a power supply for a military facility, or the like. One skilled in the art will appreciate that the power system 10 may produce electrical power in multiple phases and/or different frequencies based upon requirements of the external load 12. In one example, the power system 10 may produce and/or supply electrical power in the form of an alternating electric current such as, for example, three-phase alternating current with a preset frequency (e.g., 50 Hz, 60 Hz, or any other suitable frequency).

In another exemplary aspect, the power system 10 may be used in conjunction with a utility power grid that may be an electricity generation and/or distribution system that generates and delivers electrical power through a centralized power grid. In this aspect, the utility power grid may be configured as the primary source of power for the external load 12. For example, the utility power grid may include a nuclear-generated electrical power plant, a wind-powered generator, a solar-powered generator, a hydroelectric power plant, gas turbine power plant, coal-fired power plant, or the like. In one exemplary aspect, the utility power grid may be a fee-based electricity generation and/or distribution system that provides electrical power to one or more customers. The power system 10 in this aspect acts as a backup to the utility power grid in the case of power disruption.

The external load 12 may include any type of power consuming system or device configured to receive electrical power and to utilize the electrical power to perform some type of task. The external load 12 may include, for example, lights, motors, heating elements, electronic circuitry, refrigeration devices, air conditioning units, computers, servers, etc. In one exemplary aspect, the external load 12 may include one or more systems and/or devices that utilize uninterrupted electrical power to perform one or more critical and/or sensitive tasks. For example, the external load 12 that utilizes uninterrupted power may include those found in hospitals, airports, computers, servers, telecommunication installations, military installations, and/or industrial applications.

The power transmission network 20 may embody any electrical transmission system for distributing electrical power generated by the power system 10 to the external load 12. For example, the power transmission network 20 may include a system that includes power stations, transmission lines, connection equipment (e.g., transformers, electrical switches, power relays, circuit breakers, and the like), and other suitable devices for distributing electrical power across a power grid. In one aspect, portions of the power transmission network 20 may be buried underground and/or run overhead via transmission towers. However, the power transmission network 20 may be implemented with simpler or more complex configurations.

The connection 22 may include any type of electrical connector or system that is capable of coupling together one or more of the generator set 16, the transient management system 18, and/or the external load 12. For example, the connection 22 may include various junction boxes, circuit interrupting devices, fuses, or any other components that may be suitable for electrically interconnecting one or more systems. The connection 22 may also or alternatively include a voltage transformer configured to reduce or otherwise condition the voltage or power provided by the generator set 16, and/or the transient management system 18 to a suitable level for use by conventional consumer devices. Additionally, the connection 22 may be a hardwired connection or a connector.

The generator set 16 may include any component or components that operate to generate electricity. In one aspect, the generator set 16 may include a prime mover 24 coupled to mechanically rotate a generator 26 that provides electrical power to the external load 12. For the purposes of this disclosure, the prime mover 24 is depicted and described as a heat engine, for example an internal or external combustion engine that combusts a mixture of fuel and air to produce mechanical rotation. One skilled in the art will recognize that the prime mover 24 may be any type of combustion engine such as, for example, a diesel engine, a gasoline engine, a gaseous fuel-powered engine, gas turbine, and the like. As such, the prime mover 24 may have a desired operating range and, when operating within this range, performance of the prime mover 24 may be substantially consistent and efficient, and the electrical output of the generator 26 may have characteristics (e.g., voltage, frequency, etc.) that are substantially consistent. In one example, the desired operating range may be associated with a rotational speed of the prime mover 24. When the speed of the prime mover 24 decreases below the desired operating range, the prime mover 24 may be considered to be lagging and the electrical output of generator 26 may degrade. Similarly, when the speed of prime mover 24 increases above the desired operating range, the prime mover 24 may be considered to be overspeeding and the electrical output of the generator 26 may again degrade. It is contemplated that the prime mover 24 may alternatively embody a non-combustion source of power, for example, a fuel cell, or the like if desired.

The generator 26 may be, for example, an AC induction generator, a permanent-magnet generator, an AC synchronous generator, a switched-reluctance generator, or the like that is mechanically driven by the prime mover 24 to produce electrical power. In one aspect, the generator 26 may include multiple pairings of poles (not shown), each pairing having three phases arranged on a circumference of a stator (not shown) to produce an alternating current. The electrical power produced by the generator 26 may be directed for offboard purposes to the external load 12.

The transient management system 18 may include a plurality of components and subsystems for generating and maintaining a source of power for the power system 10. Specifically, the transient management system 18 may include a power control 28 and an energy storage device 30.

The energy storage device 30 may include any device that can store energy in potential forms such as one or more capacitors. More specifically the energy storage device 30 may be one or more ultra capacitors, such as electric double-layer capacitors (EDLC), which are also known as super capacitors, super condensers, electrochemical double layer capacitors, or ultra capacitors. The ultra capacitors may be an electrochemical capacitor or the like with relatively high energy density. The ultra capacitor energy density is typically hundreds of times greater than conventional electrolytic capacitors. The power supplied to the transient management system 18 may be used by the power control 28 to charge and/or maintain a charge within the energy storage device 30. Also, the energy storage device 30 may be implemented as a flywheel, an inductor, a battery, a fluid accumulator, and/or the like.

The transient management system 18 may further include a converter 52. The converter 52 may receive an alternating current from the generator 26. The alternating current received by the converter 52 may be converted to a high-voltage direct current, such as a 400-650 V direct current. This direct current may be applied to the power control 28 and the energy storage device 30 as discussed herein. The direct current from the converter 52 may be output from the power control 28 and the energy storage device 30 and then may also be input to an inverter 54. The inverter 54 may take the direct current and convert the direct-current to an alternating current to be provided to the connection 22 and the power transmission network 20 to provide power to the external load 12 as discussed herein.

During normal operation, the transient management system 18 may receive power from the generator set 16. At any point in time, the transient management system 18 may selectively absorb excess power supplied to the external load 12 by charging the energy storage device 30, or supplement the power directed to the external load 12 by discharging the energy storage device 30 via the power control 28.

In one example, the transient management system 18 may function to only help maintain consistent electrical output of the generator set 16 under varying loads, when generator set 16 is fully operational. In this application, the transient management system 18 may have a smaller capacity than if transient management system 18 had full UPS functionality. In this application, the transient management system 18 may smooth operation of the generator set 16 under transient loading. Such an implementation allows for a smaller energy storage device 30 reducing costs, size, weight, and the like. It is contemplated however, that transient management system 18 may have both UPS and fully-operational transient capabilities, if desired.

The power control 28 may embody an electronic device that is configured to convert, condition, and/or regulate the production, absorption, and discharge of electrical power within the transient management system 18 (i.e., the flow of power to and from energy storage device 30). In one aspect, the power control 28 may be configured to regulate the flow of electrical power by receiving an input of direct-current from the converter 52 (converted from the fixed or variable-frequency, alternating current (AC) from the generator set 16) and providing an augmented output as supplied by the energy storage device 30 to the inverter 54, to provide AC power to the external load 12.

In a particular aspect of the invention, the energy storage device 30 may be arranged in series between the converter 52 and the inverter 54. In this regard, the converter 52, the energy storage device 30, and the inverter 54 form a DC link, The DC link may be operated at approximately 400-650 V DC. However, other voltage levels are contemplated as well. The energy storage device 30 may provide 50-100 V DC to the DC link. As the energy storage device 30 is arranged in series, the 50-100 volts DC provide an increase in voltage to the DC link and to the transient management system 18 to address sudden demand fluctuations by the external load 12. Accordingly, the DC link provides an efficient arrangement to charge the energy storage device 30 and to receive power from the energy storage device 30. Moreover, as the energy storage device 30 is arranged in series, the energy storage device 30 does not need to replace the power provided by the generator set 16, the energy storage device 30 only needs to supplement the power provided by the generator set 16. Accordingly, the energy storage device 30 may have a smaller size, decreased weight, decreased cost and/or the like in comparison to prior art configurations.

When the generator set 16 is providing power to the external load 12, the power control 28 may cause energy storage device 30 to selectively absorb or supplement the power provided by the generator set 16 to the external load 12 such that fluctuating load demands of the external load 12 can be satisfied in an efficient and desired manner (i.e., allows time for the engine speed of generator set 16 to deviate from the current operating range). Accordingly, the transient management system 18 may be provided with a controller 32 to help regulate operation.

The controller 32 may embody a single or multiple microprocessors, field programmable gate arrays (FPGAs), digital signal processors (DSPs), etc. that include a means for controlling an operation of the transient management system 18 in response to various input. Numerous commercially available microprocessors can be configured to perform the functions of the controller 32. It should be appreciated that the controller 32 could readily embody a microprocessor separate from that controlling other power system functions, or the controller 32 could be integral with a general power system microprocessor and be capable of controlling numerous power system functions and modes of operation. If separate from the general power system microprocessor, the controller 32 may communicate with the general power system microprocessor via datalinks or other methods. Various other known circuits may be associated with the controller 32, including power supply circuitry, signal-conditioning circuitry, actuator driver circuitry (i.e., circuitry powering solenoids, motors, or piezo actuators), communication circuitry, other appropriate circuitry and the like.

According to one aspect, the controller 32 may be configured to monitor performance of the power system 10 and responsively regulate operation of the transient management system 18. For example, the controller 32 may monitor a voltage, a current, and/or a frequency characteristic of the electrical power provided to the external load 12 with one or more sensors 36. The output of the one or more sensors 36 may be communicated along a line 38 to the controller 32. The controller 32 may monitor a voltage, a current, and/or a frequency characteristic of the electrical power provided to the transient management system 18 with one or more sensors 40. The output of the one or more sensors 40 may be communicated along a line 42 to the controller 32. In response to a deviation of the supplied power from a desired power level (during transient operation), the controller 32 may selectively activate, deactivate, or adjust activation of the transient management system 18 to supplement or absorb the power being directed to the external load 12. Additionally or alternatively, the controller 32 may monitor operation of the generator set 16, and more specifically monitor the prime mover 24 with one or more sensors 44 providing a signal to the controller 32 along a communication line 46, and in response to an operational deviation from the desired operating range, the controller 32 may activate, deactivate, or adjust activation of the transient management system 18 and/or generator set 16. In this manner, the actual demands of the external load 12 may be satisfied while the generator set 16 is adjusted to the desired operating range.

According to another aspect, the controller 32 may predictively regulate operation of the transient management system 18. Specifically, in response to a measured, calculated, or assumed power demand change of the external load 12, the controller 32 may selectively activate, deactivate, or adjust activation of the transient management system 18. Similarly, in response to an indication of a desired load change, the controller 32 may regulate operation of the transient management system 18 to accommodate the change before the change can be measured, calculated, or assumed. In this manner, predicted demand changes of the external load 12 may be satisfied before they are actually experienced by the generator set 16.

The controller 32 may regulate operation of the transient management system 18 to absorb or supplement power provided to the external load 12 during the transient mode of operation by selectively causing the energy storage device 30 to be charged or discharged. For example, during the transient mode of operation, the controller 32 may cause the energy storage device 30 to absorb or supplement the power provided to the external load 12. For example, during the generator set 16 operation and in response to an actual or predicted sudden increase in load demand, the controller 32 may cause the power control 28 to discharge power from the energy storage device 30 to the external load 12 to account for the increase in demand such that operation of the generator set 16 remains within the desired operating range and the load demand increase is satisfied. Similarly, in response to an actual or predicted sudden decrease in load demand during the generator set 16 operation, the controller 32 may cause the power control 28 to direct excess power from the generator set 16 to charge the energy storage device 30 and account for the decrease such that operation of the generator set 16 is given time to adjust to a new desired operating range,

During a charging event, when excess power produced by the generator set 16 is being absorbed by the transient management system 18 in response to a sudden decrease in load demand of the generator set 16, the energy storage device 30 may be allowed to charge to a maximum limit. During a discharging event when the transient management system 18 is supplementing the power directed to the external load 12 to satisfy a sudden increase in load demand to help transition power supply to the generator set 16, the energy storage device 30 may be allowed to decrease as needed.

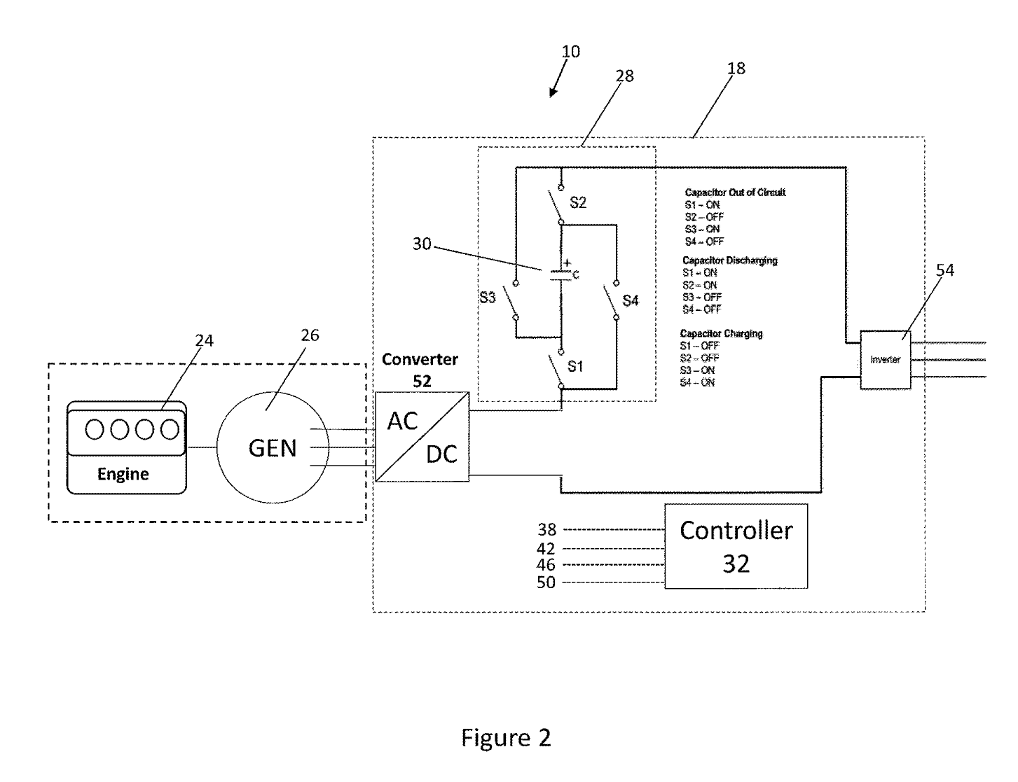

FIG. 2 shows a partial view of a generator set having a particular implementation according to an aspect of the disclosure. More specifically, FIG. 2 is a particular implementation of FIG. 1 showing a detailed implementation of the power control 28 with some of the specific details of the system removed for clarity. In particular, the power control 28 may be implemented with a series of switches S1, S2, S3, and S4. Although FIG. 2 shows a specific arrangement, number, and implementation of switches S1, S2, S3, and S4, other arrangements of switches, number of switches, and implementation of switches is within the spirit and scope of the invention. The switches S1, S2, S3, and S4 may be implemented as a field-effect transistor (FET) and/or as an insulated-gate bipolar transistor (IGBT). Other types of switch devices are contemplated and are within the spirit and scope of the invention.

In the implementation shown in FIG. 2, the actuation of switches S1, S2, S3, and S4 isolates or deactivates the energy storage device 30; activates or enables the energy storage device 30 to supplement electrical power to the external load 12; or activates or enables the energy storage device 30 to absorb electrical power or be charged.

In particular, when the switches are set such that S1 is on, S2 is off, S3 is on, and S4 is off, the energy storage device 30 will be isolated and out of the circuit. In this regard, power from the converter S2 will flow through switch S1, bypass the energy storage device 30, and flow-through switch S3. Accordingly, the energy storage device 30 will neither supplement the power to the external load 12 nor absorb electrical power from the converter 52.

When the switches are set such that S1 is on, S2 is on, S3 is off, and S4 is off, the energy storage device 30 will supplement power from the converter 52 to the external load 12. In this regard, power from the converter 52 will flow through switch S1, through the energy storage device 30, and bypass switches S3 and S4. Accordingly, the energy storage device 30 will be in series with the power from the converter 52 and supplement the power to the external load 12.

When the switches are set such that S1 is off, S2 is off, S3 is on, and S4 is on, the energy storage device 30 will receive power from the converter 52 in order to be charged. In this regard, power from the converter 52 will flow through switch S4, through the energy storage device 30, and will also flow through switch S3. Accordingly, the energy storage device 30 will be charged with the power from the converter 52 and the converter 52 will also provide power to the external load 12.

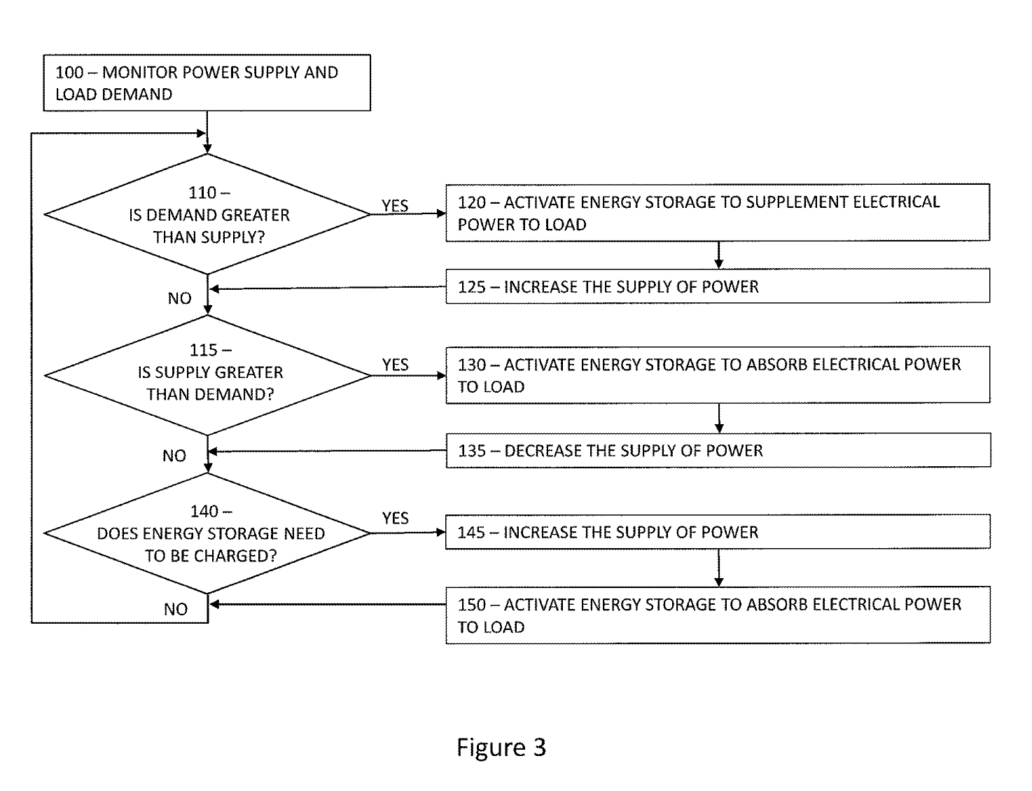

FIG. 3 shows a flowchart illustrating a process for operating the power system according to an aspect of the disclosure. During operation of the power system 10, the controller 32 may monitor characteristics associated with the power supplied to the external load 12 and/or associated with demand changes of the external load 12 (step 100). For example, the controller 32 may use current sensors, voltage sensors, frequency sensors, engine speed sensors (i.e., utilizing sensors 36, 40, 44 described above), internal calculations or assumptions, operator input, and the like to passively and/or actively monitor supply voltage, supply current, supply frequency, generator set performance (e.g., prime mover performance), utility operation, and/or external load demand changes. The controller 32 may then use these monitored characteristics to determine whether there has been or will be a change (i.e., an increase or a decrease) in power demand or power supply (step 110 and step 115). That is, controller 32 may use the characteristics to determine if during operation of the generator set 16, a demand for power from the external load 12 is greater than the supply. In any of these situations, there may be a risk of power being supplied to external load 12 with undesired characteristics (voltage, frequency, etc.) or of suboptimal prime mover operation (e.g., lagging or overspeeding).

If the power system 10 is able to feed external load 12 with sufficient electrical power (step 110: No), the controller 32 may continue the monitoring process 100 (control will advance to 115).

Returning again to step 110, if the demand for power from external load 12 increases (step 110: yes—Demand is greater than Supply), the transient management system 18 may be activated as described above to supplement the electrical power directed to the external load 12 (step 120). Thereafter, operation of the generator set 16 may optionally be adjusted to increase the supply 125 of power to address the sudden increase and provide power while maintaining performance within the desired operating range.

Next, at step 115, the power system 10 may be operating in the transient mode and the demand for power from the external load 12 decreases (step 115: yes—supply is greater than demand), the transient management system 18 may be activated as described above to absorb 130 at least a portion of the electrical power directed to the external load 12 (Step 130). Thereafter, operation of the generator set 16 may optionally be modified from the sudden decrease to decrease the supply of power 135.

Furthermore, while the power system 10 is adequately supplying electrical power to the external load 12, the power system 10 may also determine 140 (yes) to charge or maintain the charge of the energy storage device 30 by way of the power control 28, if desired. For example, in one aspect, the power system 10 may supply the power control 28 with electrical power. The power control 28 may use the electrical power to charge 150 the energy storage device 30. Additionally, if needed, the power control 28 may increase the supply of power 145 in the power system 10 by increasing output of the generator set 16. This may be accomplished by increasing the speed of the prime mover 24 and consequently the speed of the generator 26.

The disclosed power system 10 may have wide application. Specifically, because controller 32 may trigger activation or deactivation of transient management system 18 based on power supply changes, load demand changes, and/or generator set performance (i.e., actual or predicted prime mover speed deviations), power system 10 may be able to provide substantially consistent power supply.

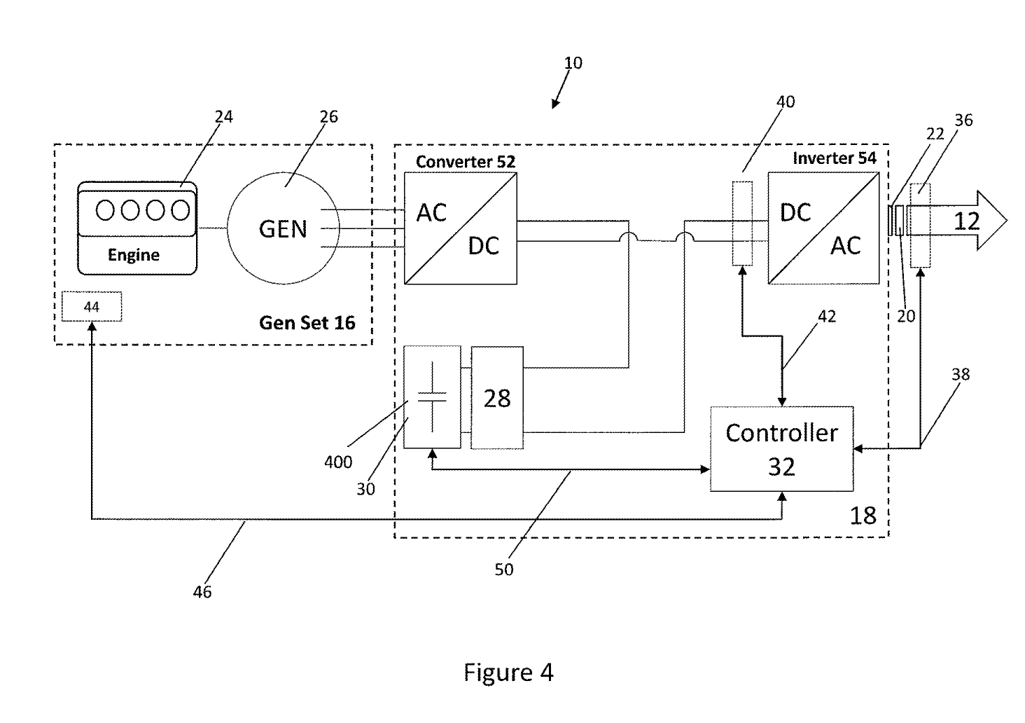

FIG. 4 shows a generator set according to an aspect of the disclosure. In particular, FIG. 4 shows the power system 10 implemented with the energy storage device 30 employing one or more ultra capacitors 400 in series between the converter 52 and the inverter 54. In a particular exemplary implementation, the ultra capacitors 400 may include 20×200 F ultra capacitors (e.g., 50V/10 F) to boost a DC Voltage by +50V during a transient period where DC Link voltage may dip as much as 150V and may allow the voltage of the ultra capacitors 400 to drop to nearly 0V during, for example, a 5 second period. Of course it is contemplated that other arrangements, number, and types of ultra capacitors 400 may be implemented and are within the scope and spirit of the invention.

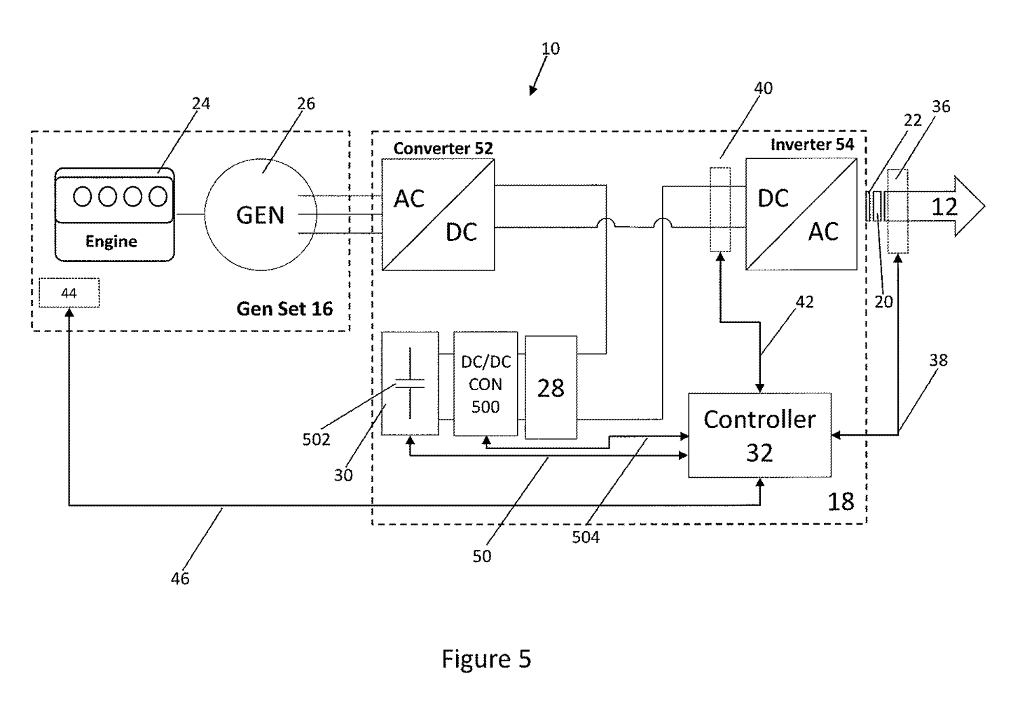

FIG. 5 shows a generator set according to an aspect of the disclosure. In particular, FIG. 5 shows the power system 10 implemented with the energy storage device 30 employing one or more ultra capacitors 502 in series between the converter 52 and the inverter 54. Additionally, the transient management system 18 further includes a DC to DC converter 500 (DC/DC Con). The DC to DC converter 500 converts a voltage level between the energy storage device 30 and the inverter 54 or the converter 52. In this regard, the DC to DC converter 500 adjusts the voltage level as needed by the energy storage device 30 or adjusts the voltage level as needed by the inverter 54. Additionally, the controller 32 may operate to control the voltage level of the DC to DC converter 500 as shown by line 504. Finally, the line 504 may also provide data to the controller 32 including voltage, current, condition or the like of the DC to DC converter 500.

In a particular exemplary implementation, the ultra capacitors 502 may include 10×400 F ultra capacitors (e.g., 25V/4 F) to provide power to the DC to DC converter 500. Alternatively, to limit voltage drop, the ultra capacitors 502 may include 10×800 F ultra capacitors (e.g., 25V/8 F). Of course it is contemplated that other arrangements, number, and types of ultra capacitors 502 may be implemented and are within the scope and spirit of the invention.

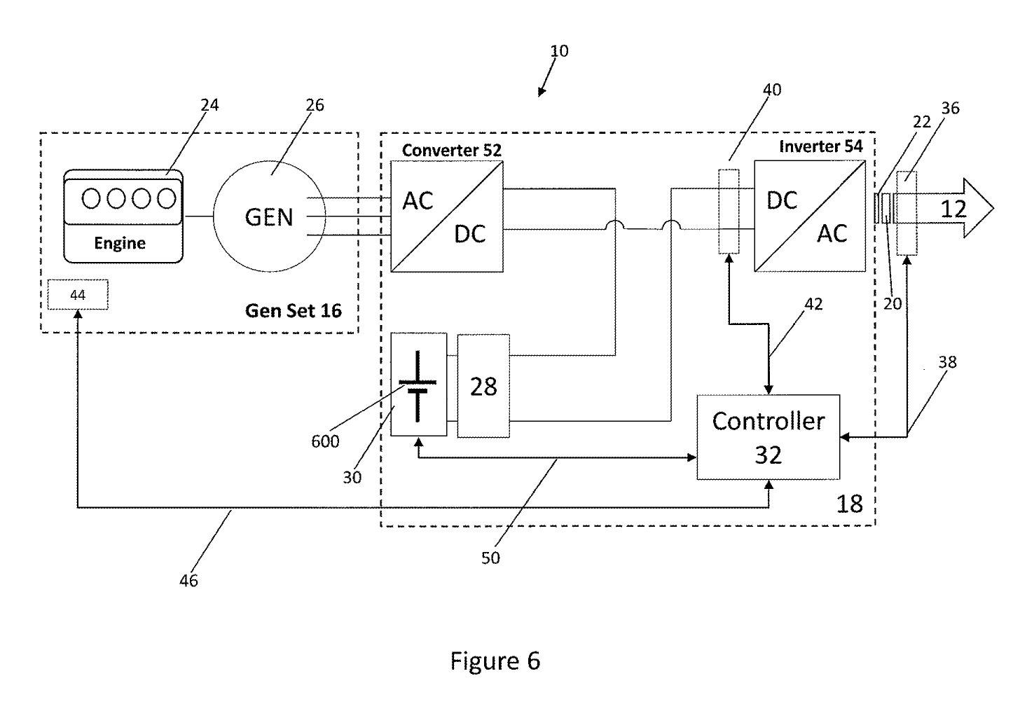

FIG. 6 shows a generator set according to an aspect of the disclosure. In particular, FIG. 6 shows the power system 10 implemented with the energy storage device 30 employing one or more lithium ion batteries 600 (Li-ion battery or LIB) in series between the converter 52 and the inverter 54. For example only, the lithium ion storage device 30 may utilize lithium iron phosphate batteries (LiFePO₄), also known as LFP batteries. In a particular exemplary implementation, the lithium ion batteries 600 may be implemented with a pack voltage of about 50-100V. In this aspect, the controller 32 may need to operate such that the battery voltage does not decrease as much as the ultra capacitor aspect. Thus, the batteries 600 may need to be switched out sooner as the prime mover 24 is ramped up to a certain threshold in order to avoid overvoltage at the DC Link when the generator set 16 reaches a higher power output. Of course it is contemplated that other arrangements, number, and types of lithium ion batteries 600 may be implemented and are within the scope and spirit of the invention.

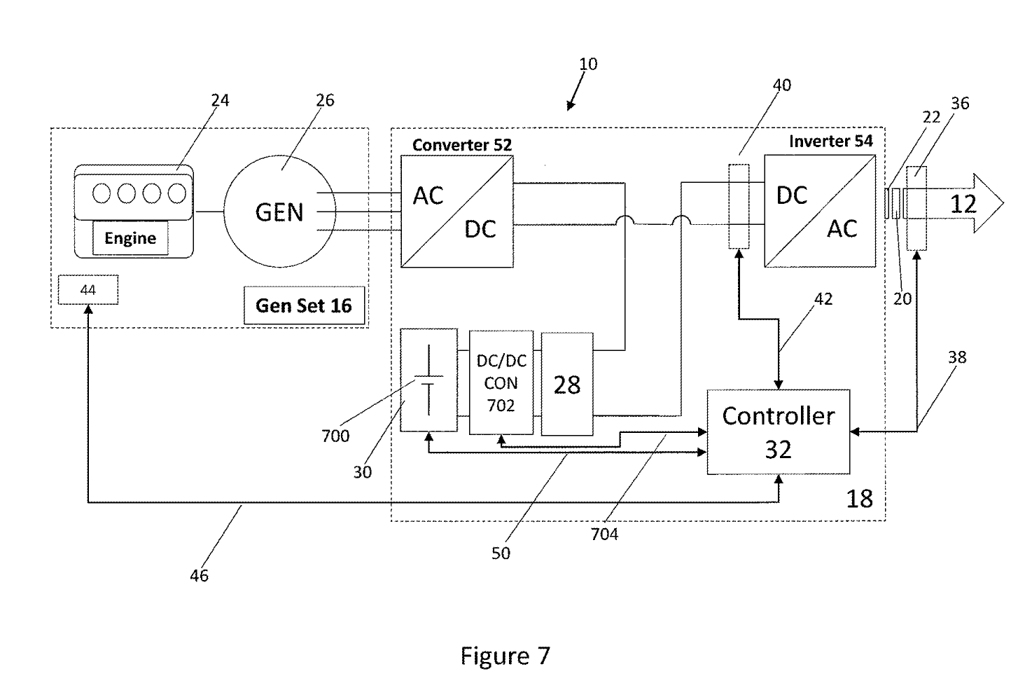

FIG. 7 shows a generator set according to an aspect of the disclosure. In particular, FIG. 7 shows the power system 10 implemented with the energy storage device 30 employing one or more lithium ion batteries 600 in series between the converter 52 and the inverter 54. Additionally, the transient management system 18 further includes a DC to DC converter 702 (DC/DC Con). The DC to DC converter 702 converts a voltage level between the energy storage device 30 and the inverter 54 or the converter 52. In this regard, the DC to DC converter 702 adjusts the voltage level as needed by the energy storage device 30 or adjusts the voltage level as needed by the inverter 54. Additionally, the controller 32 may operate to control the voltage level of the DC to DC converter 702 as shown by line 704. Finally, the line 704 may also provide data to the controller 32 including voltage, current, condition or the like of the DC to DC converter 702.

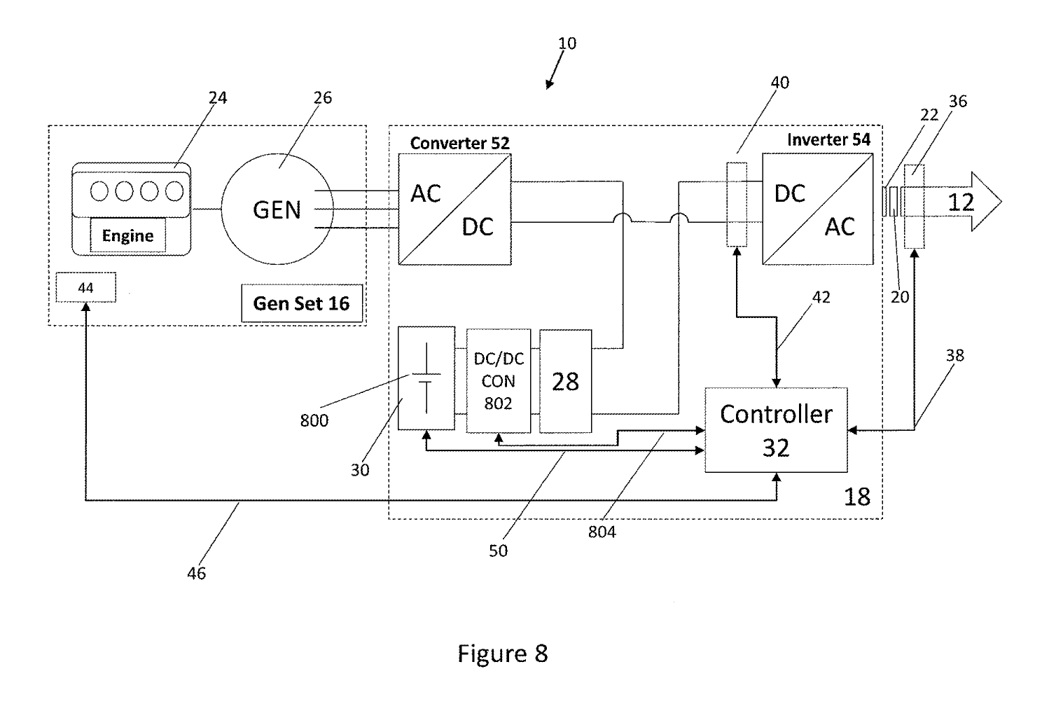

FIG. 8 shows a generator set according to an aspect of the disclosure. In particular, FIG. 8 shows the power system 10 implemented with an energy storage device 30 employing one or more premium high-power lead acid batteries 800 in series between the converter 52 and the inverter 54. Additionally, the transient management system 18 further includes a DC to DC converter 802 (DC/DC Con). The DC to DC converter 802 converts a voltage level received from/provided to the energy storage device 30 to a different voltage level for the power delivered to the inverter 54 or a different voltage level for the power received from the converter 52. In this regard, the DC to DC converter 802 adjusts the voltage level as needed by the energy storage device 30 or adjusts the voltage level needed by the inverter 54. Additionally, the controller 32 may operate to control the voltage level of the DC to DC converter 802 as shown by line 804. Finally, the line 804 may also provide data to the controller 32 including voltage, current, condition or the like of the DC to DC converter 802.

### INDUSTRIAL APPLICABILITY

The disclosed power system may provide consistent power to an external load in an efficient manner. The disclosed system may be used during a transient period of backup power source operation to accommodate sudden load changes that might otherwise cause inefficient or undesired operation of the backup power source.

The disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A power system, comprising:
a prime mover configured to generate a drive force;
a generator configured to receive the drive force and be driven by the prime mover to produce electrical power;
a connection configured to receive the electrical power from the generator and direct the electrical power to an external load;
a power storage device arranged in series with the connection between the generator and the external load, the power storage device configured to store electrical power from the generator or to discharge power to the external load; and
a controller to control the power storage device, the controller configured to determine a supply of electrical power and a demand for electrical power by the external load, the controller being further configured to control the power storage device to store at least a portion of the electrical power to charge the power storage device or to discharge power to supplement the electrical power from the generator directed to the external load.

2. The power system of claim 1, wherein the power storage device includes at least one of an ultra capacitor, a lithium ion battery, and a high-power lead acid battery.

3. The power system of claim 1, wherein the connection includes a converter configured to convert AC power from the generator to DC and the connection further includes an inverter configured to receive DC power from at least one of the converter and the power storage device and generate AC power for the external load.

4. The power system of claim 3, further comprising a power control configured to connect the power storage device in series with the connection to supplement power to the external load.

5. The power system of claim 3, further comprising a power control configured to connect the power storage device with the connection to receive power from the generator.

6. The power system of claim 3, further comprising a power control configured to disconnect the power storage device from the connection.

7. The power system of claim 1, further comprising a DC to DC converter configured to change a voltage between the connection and the power storage device.

8. A power system, comprising:
means for producing a drive force;
means for generating electrical power in response to receiving the drive force from the means for producing a drive force;
means for connecting to receive the electrical power from the means for generating and the means for connecting further directing the electrical power to an external load;
means for storing arranged in series with the means for connecting between the means for generating and the external load, the means for storing stores electrical power to charge the means for storing or to discharge power from the means for storing; and
a means for controlling to control the means for storing and configured to determine a supply of electrical power and a demand for electrical power by the external load, the means for controlling being further configured to control the means for storing to store at least a portion of the electrical power from the means for generating to charge the means for storing or to discharge power from the means for storing to supplement the electrical power from the means for generating directed to the external load.

9. The power system of claim 8, wherein the means for storing includes at least one of an ultra capacitor, a lithium ion battery, and a high-power lead acid battery.

10. The power system of claim 8, wherein the means for connecting includes a converter configured to receive power from the means for generating and the means for connecting further includes an inverter configured to receive power from at least one of the converter and the means for storing.

11. The power system of claim 10, further comprising a means for power controlling configured to connect the means for storing in series with the means for connecting to supplement power to the external load.

12. The power system of claim 10, further comprising a means for power controlling configured to connect the means for storing with the means for connecting to receive power from the means for generating.

13. The power system of claim 10, further comprising a means for power controlling configured to disconnect the means for storing from the means for connecting.

14. A process of operating a power system, comprising:
producing a drive force;
generating electrical power in response to receiving the drive force;
directing the electrical power to an external load;
determining a supply of electrical power and a demand for electrical power by the external load;
storing electrical power in a power storage device when the supply of electrical power is greater than the demand for electrical power by the external load; and
discharging electrical power from the power storage device together with the directing the electrical power when the demand for electrical power is greater than the supply of electrical power by the external load.

15. The process of claim 14, wherein storing electrical power comprises storing electrical power in at least one of an ultra capacitor, a lithium ion battery, and a high-power lead acid battery.

16. The process of claim 14, further comprising converting AC power to DC power after the step of generating and before the step of storing electrical power and discharging electrical power.

17. The process of claim 14, further comprising converting DC power to AC power after the step of storing electrical power and discharging electrical power.

18. The process of claim 14, further comprising connecting the storage device in series to supplement power to the external load, connecting the storage device to receive power, and disconnecting the storage device.

19. The process of claim 14, further comprising:
converting AC power to DC power after the step of generating and before the step of storing electrical power and discharging electrical power; and
converting DC power to AC power after the step of storing electrical power and discharging electrical power.
